(19) United States
(12) Patent Application Publication
(10) Pub. No.: US 2021/0352183 A1
(43) Pub. Date: Nov. 11, 2021

(54) ELECTRONIC DEVICE, COMPUTER-READABLE NON-TEMPORARY RECORDING MEDIUM STORING OPERATION SCREEN CONTROL PROGRAM, AND INFORMATION PROCESSING SYSTEM

(71) Applicant: KYOCERA Document Solutions Inc., Osaka-shi (JP)

(72) Inventor: Masato Hirota, Osaka-shi (JP)

(21) Appl. No.: 17/241,388

(22) Filed: Apr. 27, 2021

(30) Foreign Application Priority Data
May 8, 2020 (JP) 2020-082493

(51) Int. Cl. H04N 1/00

(52) U.S. Cl. CPC H04N 1/00503; H04N 1/00506; H04N 1/00949; H04N 1/00933; H04N 1/00514

(57) ABSTRACT

An image forming device stores operation screen information showing various information of an operation screen in the image forming device; displays the operation screen that corresponds to the stored operation screen information; stores, as an operation screen information candidate which is a candidate for the operation screen information, various information, of a new operation screen, sent from outside; and updates (S224), at a timing according to contents of a difference between the various information of the operation screen shown in the stored operation screen information candidate and the various information of the operation screen shown in the stored operation screen information, the stored operation screen information with the stored operation screen information candidate.

### INCORPORATION BY REFERENCE

This application is based upon, and claims the benefit of priority from, corresponding Japanese Patent Application No. 2020-082493 filed in the Japan Patent Office on May 8, 2020, the entire contents of which are incorporated herein by reference.

### BACKGROUND

### Field of the Invention

The present disclosure relates to an electronic device capable of updating an operation screen, a computer-readable non-temporary recording medium storing an operation screen control program, and an information processing system.

### Description of Related Art

As a typical electronic device, a device capable of updating an operation screen is known.

### SUMMARY

An electronic device of the present disclosure is an electronic device that includes the following operations: storing operation screen information showing various information of an operation screen in the electronic device; displaying the operation screen that corresponds to the operation screen information stored by the electronic device itself storing, as a candidate for the operation screen information, various information, of a new operation screen, sent from outside; and updating, at a timing according to contents of a difference between the various information of the operation screen shown in the candidate stored by the electronic device itself and the various information of the operation screen shown in the operation screen information stored by the electronic device itself, the operation screen information stored by the electronic device itself with the candidate stored by the electronic device itself.

A computer-readable non-temporary recording medium of the present disclosure stores an operation screen control program, the operation screen control program is an operation screen control program for controlling an operation screen in an electronic device and includes the following operations: causing the electronic device to store operation screen information showing various information of the operation screen; causing the electronic device to display the operation screen that corresponds to the operation screen information stored by the electronic device; causing the electronic device to store, as a candidate for the operation screen information, various information, of a new operation screen, sent from outside of the electronic device to the electronic device; and causing the electronic device to update, at a timing according to contents of a difference between the various information of the operation screen shown in the candidate stored by the electronic device and the various information of the operation screen shown in the operation screen information stored by the electronic device, the operation screen information stored by the electronic device with the candidate stored by the electronic device.

An information processing system of the present disclosure includes: an electronic device; and a setting device that sets an operation screen in the electronic device, wherein the electronic device stores operation screen information showing various information of the operation screen, the electronic device displays the operation screen that corresponds to the operation screen information stored by the electronic device itself, the setting device sends various information of a new operation screen to the electronic device, the electronic device stores, as a candidate for the operation screen information, the various information of the new operation screen sent from the setting device, and the electronic device updates, at a timing according to contents of a difference between the various information of the operation screen shown in the candidate stored by the electronic device itself and the various information of the operation screen shown in the operation screen information stored by the electronic device itself, the operation screen information stored by the electronic device itself with the candidate stored by the electronic device itself.

### BRIEF DESCRIPTION OF THE DRAWINGS

FIG. 1 is a block diagram of an information processing system according to one embodiment of the present disclosure;

FIG. 2 is a block diagram of an image forming device shown in FIG. 1 when the image forming device is configured by an MFP;

FIG. 3 is a diagram showing an example of button group information shown in FIG. 2;

FIG. 4 is a diagram showing an example of an operation screen displayed on a display unit by a client application shown in FIG. 2;

FIG. 5 is a block diagram of a user terminal shown in FIG. 1;

FIG. 6 is a sequence diagram of the operation of the information processing system shown in FIG. 1 when a user logs in to the image forming device by using a combination of a user name and a password;

FIG. 7 is a sequence diagram of the operation of the information processing system shown in FIG. 1 when the image forming device uses a document processing flow execution system by using a ticket sent from a user information holding system;

FIG. 8 is a sequence diagram of the operation of the information processing system shown in FIG. 1 when the user logs in to the image forming device by using a PIN code;

FIG. 9 is a sequence diagram of the operation of the information processing system shown in FIG. 1 when the image forming device uses the document processing flow execution system by using a ticket sent from an authentication/authorization system;

FIG. 10 is a flowchart of the operation of the user terminal shown in FIG. 5 when the operation screen of the image forming device is edited;

FIG. 11 is a diagram showing an example of an operation screen editing screen displayed on the display unit in the operation shown in FIG. 10;

FIG. 12 is a sequence diagram of the operation of the information processing system shown in FIG. 1 when various information of the operation screen is sent from the user terminal to the image forming device;

FIG. 13 is a flowchart of a part of the operation of the image forming device shown in FIG. 2 when the operation screen information is updated;

FIG. 14 is a flowchart of an operation following the operation shown in FIG. 13; and

FIG. 15 is a flowchart of an operation different from the operation shown in FIG. 13 of the image forming device shown in FIG. 2 when the operation screen information is updated.

### DETAILED DESCRIPTION

The following describes embodiments of the present disclosure using the accompanying drawings.

First, a configuration of an information processing system according to one embodiment of the disclosure will be described.

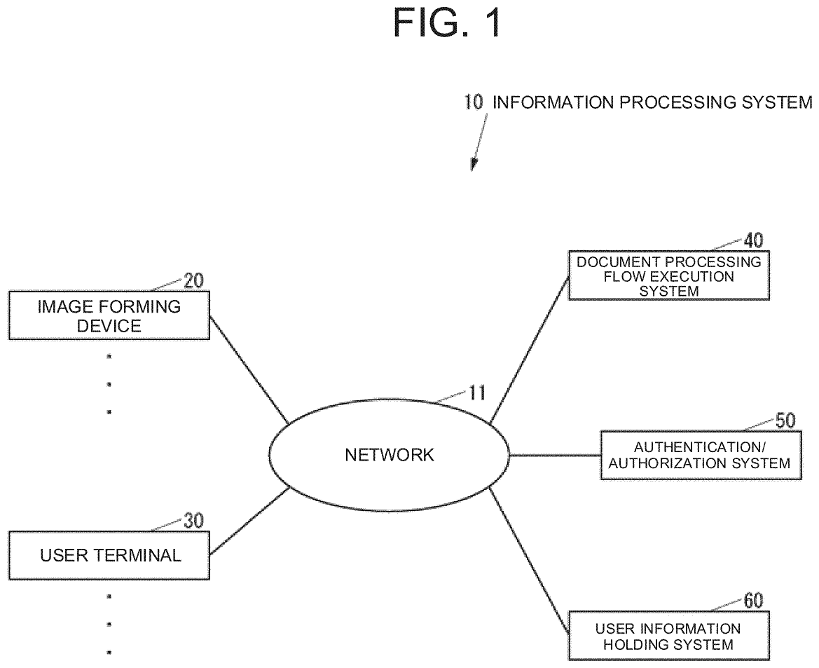

FIG. 1 is a block diagram of an information processing system 10 according to the present embodiment.

As shown in FIG. 1, the information processing system 10 includes an image forming device 20 as an electronic device. Other than the image forming device 20, the information processing system 10 may include at least one image forming device having the same configuration as the image forming device 20. The image forming device in the information processing system 10 is composed of, for example, an MFP (Multifunction Peripheral), a printer-dedicated machine, and the like.

The information processing system 10 includes a user terminal 30 used by a user. The user terminal 30 can set an operation screen in the image forming device, and constitutes a setting device of the present disclosure. Other than the user terminal 30, the information processing system 10 may include at least one user terminal having the same configuration as the user terminal 30. The user terminal in the information processing system 10 is composed of, for example, a computer such as a PC (Personal Computer).

The information processing system 10 includes a document processing flow execution system 40 that executes a document processing flow as a workflow of document processing. The document processing flow execution system 40 may be configured by one computer or may be configured by a plurality of computers. The document processing flow executed by the document processing flow execution system 40 includes an input stage in which a document is input, a document processing stage in which various processes are executed on the document input in the input stage, and an output stage in which a result of the processing in the document processing stage is output. There are various methods as a method of inputting a document at the input stage, for example, a method of inputting, as a document, an image read from a manuscript by a scanner of an image forming device, a method of inputting a document arranged in a specific folder, and a method of inputting a document attached to a received e-mail. As the processes for a document in the document processing stage, there are various processes, for example, an OCR (Optical Character Recognition) process for generating a text from an image as a document, a Zone OCR process for generating a text from a part of an image as a document, a process of executing, on an image as a document, specific image processing such as tilt correction, dot removal, and noise removal, and a process of converting the format of an image as a document. As a method of outputting the processing result in the output stage, there are various methods such as a method of outputting to a specific folder and a method of sending to a specific destination by e-mail. The document processing flow execution system 40 can store a plurality of document processing flows.

The information processing system 10 can include an authentication/authorization system 50 that executes authentication and authorization of the user of the information processing system 10. The authentication/authorization system 50 may be composed of one computer or a plurality of computers. The authentication/authorization system 50 manages, for each user, restrictions on the use of various functions of the image forming device, and can provide the image forming device and the document processing flow execution system 40 with authorization information that relates to an authenticated user, that is, a user who has logged in to the image forming device and that shows restrictions on the use of various functions of the image forming device. The authentication/authorization system 50 can, for example, spool the print data sent from the user terminal and output the spooled print data to any of the image forming devices. The authentication/authorization system 50 can also manage the use of the image forming device by the user of the information processing system 10. The authentication/authorization system 50 can register, for each user, an IC (Integrated Circuit) card ID.

The information processing system 10 can include a user information holding system 60 that holds information about the users of the information processing system 10. The user information holding system 60 may be configured by one computer or may be configured by a plurality of computers. The user information holding system 60 can also hold information used in a system that is neither the document processing flow execution system 40 nor the authentication/authorization system 50.

The image forming device in the information processing system 10, the user terminal in the information processing system 10, the document processing flow execution system 40, the authentication/authorization system 50, and the user information holding system 60 are communicably connectable via a network 11 such as a LAN (Local Area Network).

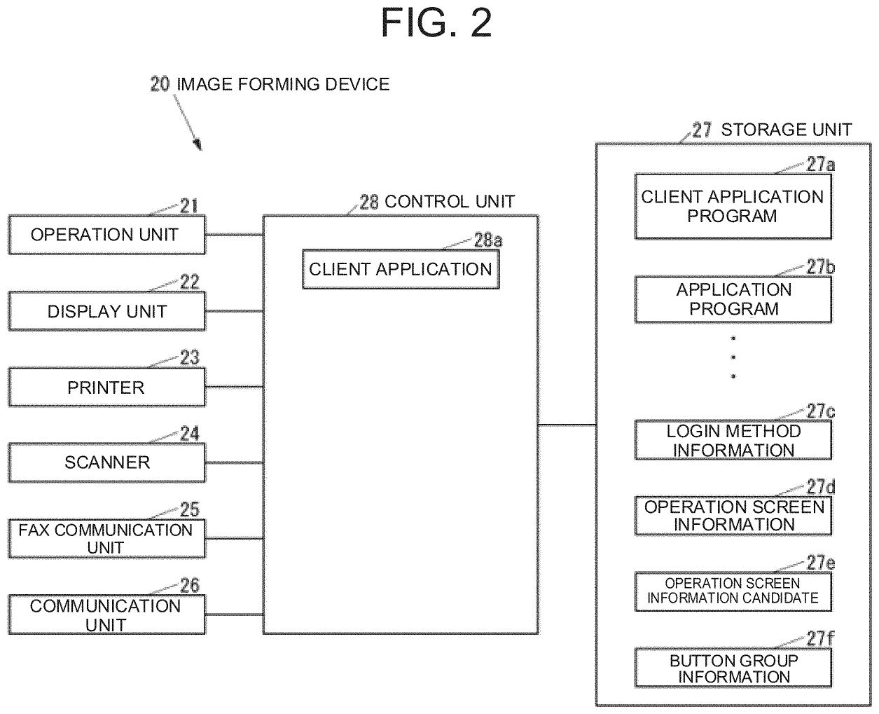

FIG. 2 is a block diagram of the image forming device 20 when the image forming device 20 is configured by an MFP.

As shown in FIG. 2, the image forming device 20 is a computer including an operation unit 21 which is an input device such as a button into which various operations are input, a display unit 22 which is a display device such as an LCD (Liquid Crystal Display) and the like which displays various information, a printer 23 as a printing device that prints an image on a recording medium such as paper, a scanner 24 as a reading device that reads an image from a manuscript, a fax communication unit 25 which is a fax device that performs a fax communication, with an external facsimile machine (not shown), via a communication line such as a public telephone line, a communication unit 26 which is a communication device that performs a communication with an external device via a network such as LAN and the Internet, or directly without the network by wire or wirelessly, a storage unit 27 which is a non-volatile storage device such as a semiconductor memory and an HDD (Hard Disk Drive) that store various information, and a control unit 28 that controls entirety of the image forming device 20.

The storage unit 27 can store a client application program 27a as an application program for providing the user with the functions of the image forming device 20, the document processing flow execution system 40 (see FIG. 1), and the authentication/authorization system 50 (see FIG. 1). The client application program 27a may be, for example, installed in the image forming device 20 at the manufacturing stage of the image forming device 20, may be additionally installed in the image forming device 20 from an external storage medium such as a USB (Universal Serial Bus) memory, or may be additionally installed on the image forming device 20 from the network. The client application program 27a is a program capable of controlling the operation screen in the image forming device 20, and constitutes an operation screen control program of the present disclosure.

The storage unit 27 can store an application program 27b different from the client application program 27a. The storage unit 27 can store at least one application program different from the client application program 27a, other than the application program 27b.

Only one application program, that is to be installed in the image forming device 20, can be installed in the image forming device 20. When the image forming device 20 is started in the case where the only one application program is installed, there are an extended authentication application program that is first started to display an authentication screen on the display unit 22, and an extended application program that is an application program other than the extended authentication application program. The client application program 27a is an extended authentication application program.

The storage unit 27 can store login method information 27c showing a login method on the authentication screen of the image forming device 20. The login method information 27c shows any of a login method by using a combination of a user name and a password, a login method by using a PIN (Personal Identification Number) code, a login method by using an IC card ID, and a method which is a combination of the above methods.

The storage unit 27 can store an operation screen information 27d showing various information of the operation screen of the image forming device 20 and an operation screen information candidate 27e which is a candidate for the operation screen information 27d.

The storage unit 27 can store button group information 27f showing a group of buttons that may be included in the operation screen of the image forming device 20.

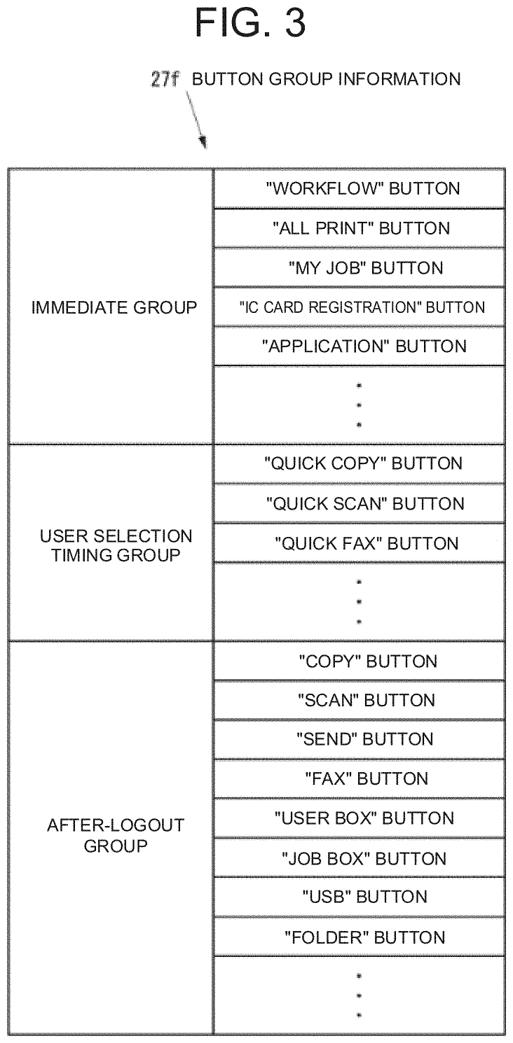

FIG. 3 is a diagram showing an example of the button group information 27f.

As shown in FIG. 3, the groups shown in the button group information 27f include an immediate group showing a group of buttons with which the update of the operation screen is immediately reflected when the bottoms themselves are deleted, a user selection timing group that shows a group of buttons with which the update of the operation screen is reflected, at the timing selected by the user, when the user selection timing group is deleted in the case where the button belonging to the immediate group is not deleted, and an after-logout group that shows a group of buttons with which the update of the operation screen is, after the user logs out from the image forming device 20, reflected when the after-logout group itself is deleted in the case where none of the button belonging to the immediate group and the button belonging to the user selection timing group are deleted.

The immediate group includes a button that may not be able to appropriately perform the operation that corresponds to an operation by the user. For example, the immediate group includes a button for linking with an external system of the image forming device 20 and a button for linking with an application program other than the client application program 27a. The buttons for linking with the external system of the image forming device 20 include, for example, a button for linking with the document processing flow execution system 40 and a button for linking with the authentication/authorization system 50.

The button for linking with the document processing flow execution system 40 includes, for example, a “Workflow” button for executing the document processing flow saved in the document processing flow execution system 40. When the document processing flow corresponding to the “Workflow” button is deleted from the document processing flow execution system 40, the image forming device 20, even if the “Workflow” button is operated by the user, cannot appropriately execute the document processing flow that corresponds to this “Workflow” button.

Examples of buttons for linking with the authentication/authorization system 50 include a “Print All” button for executing, by the printer 23, a printing operation which is based on all the print data that are spooled in the authentication/authorization system 50 and that belong to the user in a state of logging in to the image forming device 20, a “My Job” button for executing, by the printer 23, a printing operation which is based on the print data that are spooled in the authentication/authorization system 50 and that are selected by the user each time from the print data of the user in a state of logging in to the image forming device 20, and an “IC card registration” button for registering, in the authentication/authorization system 50, the ID of the IC card of the user in a state of logging in to the image forming device 20. When the print data spooled in the authentication/authorization system 50 cannot be obtained from the authentication/authorization system 50, the image forming device 20, even with the “Print All” button or the “My Job” button operated by the user, cannot appropriately execute the operations that correspond to the “Print All” button or the “My Job” button. Further, when the IC card ID cannot be registered in the authentication/authorization system 50, the image forming device 20, even with the “IC card registration” button operated by the user, cannot appropriately execute the operation that corresponds to the “IC card registration” button.

Buttons for linking with an application program other than the client application program 27a include, for example, an “Application” button that is installed in the image forming device 20 and that is for executing a specific application program other than the client application program 27a. When the application program corresponding to the “Application” button is uninstalled from the image forming device 20, the image forming device 20, even with this “Application” button operated by the user, cannot appropriately execute the application program corresponding to this “Application” button.

The user selection timing group includes buttons that can appropriately execute operations that correspond to user operations, but may not be able to execute operations with the latest setting. For example, the user selection timing group includes a button for executing the function of the image forming device 20 with a preset setting. Buttons for executing the functions of the image forming device 20 with the preset setting include, for example, a “Quick Copy” button for quickly executing a copying operation with the setting that corresponds to the preset value, a “Quick Scan” button for quickly executing a scanning operation with the setting that corresponds to the preset value, and a “Quick Fax” button for quickly executing a fax transmission with the setting that corresponds to the preset value.

The after-logout group includes, for example, a button for executing the function of the image forming device 20 in a state where the setting is not preset, and a button for executing the function completed in the client application program 27a.

Examples of buttons for executing the functions of the image forming device 20 in a state where the setting is not preset include a “Copy” button for executing the copying operation with the setting that corresponds to the value specified by the user each time, a “Scan” button for executing the scan with the setting that corresponds to the value specified by the user each time, a “Send” button for executing a scan transmission with the setting that corresponds to the value specified by the user each time, a “Fax” button for executing a fax transmission with the setting that corresponds to the value specified by the user each time, a “User Box” button for saving, in a specific area on the storage unit 27, an image read from the manuscript by the scanner 24 and for printing, with the printer 23, an image saved in this area, a “Job Box” button for saving, in a specific area on the storage unit 27, data received from an external electronic device such as a PC and for executing a printing operation which is based on the data saved in this area, and a “USB” button for saving, in a USB memory connected to the image forming device 20, the image read from the manuscript by the scanner 24 and for executing a printing operation which is based on the data saved in the USB memory connected to the image forming device 20.

As a button for executing the function completed in the client application program 27a, for example, there is a “Folder” button for moving to an operation screen one level below the current operation screen.

The control unit 28 shown in FIG. 2 is provided with, for example, a CPU (Central Processing Unit), a ROM (Read Only Memory) that stores a program and various data, and a RAM (Random Access Memory) as a volatile storage device used as a work area of the CPU of the control unit 28. The CPU of the control unit 28 executes a program stored in the storage unit 27 or in the ROM of the control unit 28.

The control unit 28 realizes a client application 28a by executing the client application program 27a. According to the authorization information obtained from the authentication/authorization system 50, the client application 28a can restrict the use of various functions of the image forming device 20, such as “Scan” which is the reading, by the scanner 24, of an image from the manuscript, “Print Output” for printing, on the recording medium by the printer 23, various images such as an image that is based on the print data received via the communication unit 26, “Copy” for printing, on the recording medium by the printer 23, the image read by the scanner 24 from the manuscript, “Fax Transmission” for sending the image, which is read by the scanner 24 from the manuscript, through a fax communication by the fax communication unit 25, and “Scan Transmission” for sending, by the communication unit 26, the image read by the scanner 24 from the manuscript.

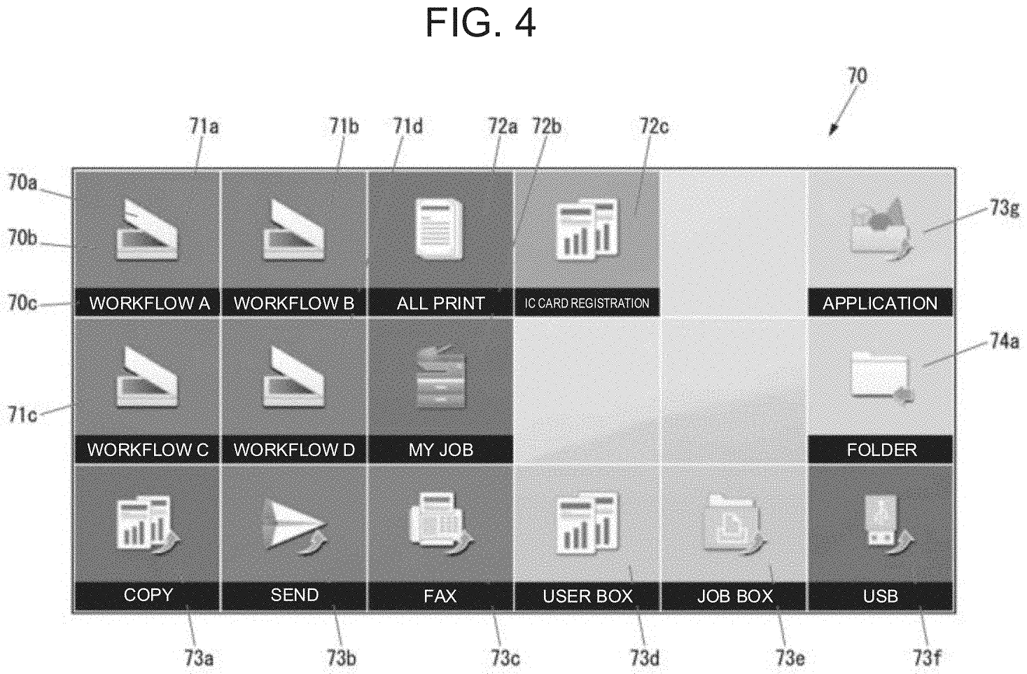

FIG. 4 is a diagram showing an example of an operation screen 70 displayed on the display unit 22 (see FIG. 2) by the client application 28a (see FIG. 2).

In the operation screen 70 shown in FIG. 4, buttons associated with the functions and the like of the image forming device 20 (see FIG. 1), the document processing flow execution system 40 (see FIG. 1), and the authentication/authorization system 50 (see FIG. 1) are arranged. With a button, which is arranged on the operation screen 70, tapped, the client application 28a can use the function and the like associated with this button. Each of the buttons arranged on the operation screen 70 is composed of an icon image 70a, a background 70b of the icon image 70a, and a character string 70c arranged below the icon image 70a.

Examples of the buttons arranged on the operation screen 70 include a “Workflow A” button 71a as a “Workflow” button for executing a document processing flow A which is a specific document processing flow saved in the document processing flow execution system 40, a “Workflow B” button 71b as a “Workflow” button for executing a document processing flow B which is a specific document processing flow saved in the document processing flow execution system 40, a “Workflow C” button 71c as a “Workflow” button for executing a document processing flow C which is a specific document processing flow saved in the document processing flow execution system 40, and a “Workflow D” button 71d as a “Workflow” button for executing a document processing flow D which is a specific document processing flow saved in the document processing flow execution system 40. The “Workflow A” button 71a, the “Workflow B” button 71b, the “Workflow C” button 71c, and the “Workflow D” button 71d are buttons associated with the functions of the document processing flow execution system 40.

The buttons arranged on the operation screen 70 include, for example, a “Print All” button 72a, a “My Job” button 72b, and an “IC card registration” button 72c. The “Print All” button 72a, the “My Job” button 72b, and the “IC card registration” button 72c are buttons associated with the functions of the authentication/authorization system 50.

The buttons arranged on the operation screen 70 include, for example, a “Copy” button 73a, a “Send” button 73b, a “Fax” button 73c, a “User Box” button 73d, a “Job Box” button 73e, a “USB” button 73f, and an “Application” button 73g. The “Copy” button 73a, the “Send” button 73b, the “Fax” button 73c, the “User Box” button 73d, the “Job Box” button 73e, the “USB” button 73f, and the “Application” button 73g are associated with the functions of the image forming device 20.

Other than the “Copy” button 73a, the “Send” button 73b, the “Fax” button 73c, the “User Box” button 73d, the “Job Box” button 73e, the “USB” button 73f, and the “Application” button 73g, the buttons associated with the functions of the image forming device 20 include, for example, a “Scan” button, a “Quick Copy” button, a “Quick Scan” button and a “Quick Fax” button.

The buttons arranged on the operation screen 70 include, for example, a “Folder” button 74a for moving to an operation screen one level below the operation screen 70. Similar to the operation screen 70, the operation screen that is moved with the “Folder” button 74a tapped may be provided with a button associated with the function of at least one of the image forming device 20, the document processing flow execution system 40, and the authentication/authorization system 50.

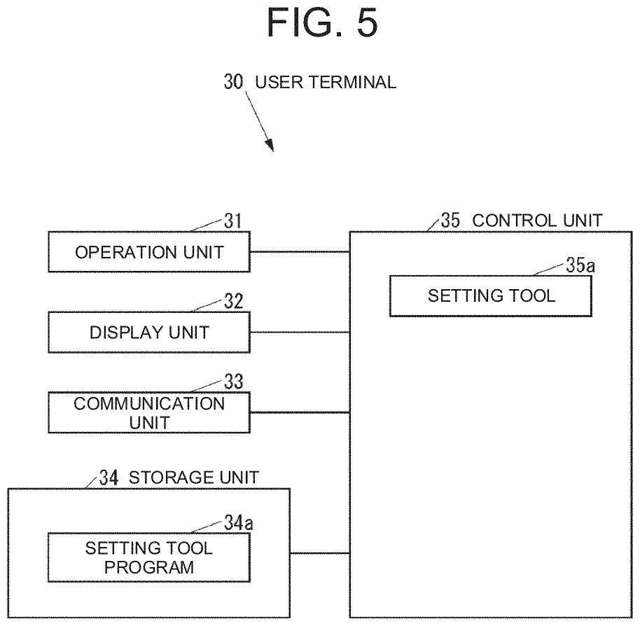

FIG. 5 is a block diagram of the user terminal 30.

As shown in FIG. 5, the user terminal 30 includes an operation unit 31 as an operation device such as a keyboard and a mouse into which various operations are input, a display unit 32 as a display device such as an LCD which displays various information, a communication unit 33 which is a communication device that performs a communication with an external device via a network such as LAN and the Internet, or directly without the network by wire or wirelessly, a storage unit 34 which is a non-volatile storage device such as a semiconductor memory and an HDD that store various information, and a control unit 35 that controls entirety of the user terminal 30.

The storage unit 34 stores a setting tool program 34a for setting the client application program 27a (see FIG. 2). For example, the setting tool program 34a may be installed in the user terminal 30 at the manufacturing stage of the user terminal 30, may be additionally installed on the user terminal 30 from an external storage medium such as a CD (Compact Disk), a DVD (Digital Versatile Disk), and a USB memory, or may be additionally installed on the user terminal 30 from the network.

The control unit 35 includes, for example, a CPU, a ROM storing programs and various data, and a RAM as a volatile storage device used as a work area of the CPU of the control unit 35. The CPU of the control unit 35 executes the program stored in the storage unit 34 or in the ROM of the control unit 35.

The control unit 35 realizes a setting tool 35a by executing the setting tool program 34a. The setting tool 35a can install the client application program on the image forming device.

Next, the operation of the information processing system 10 will be described.

First, the operation of the information processing system 10 when the user logs in to the image forming device 20 by using the combination of the user name and the password will be described.

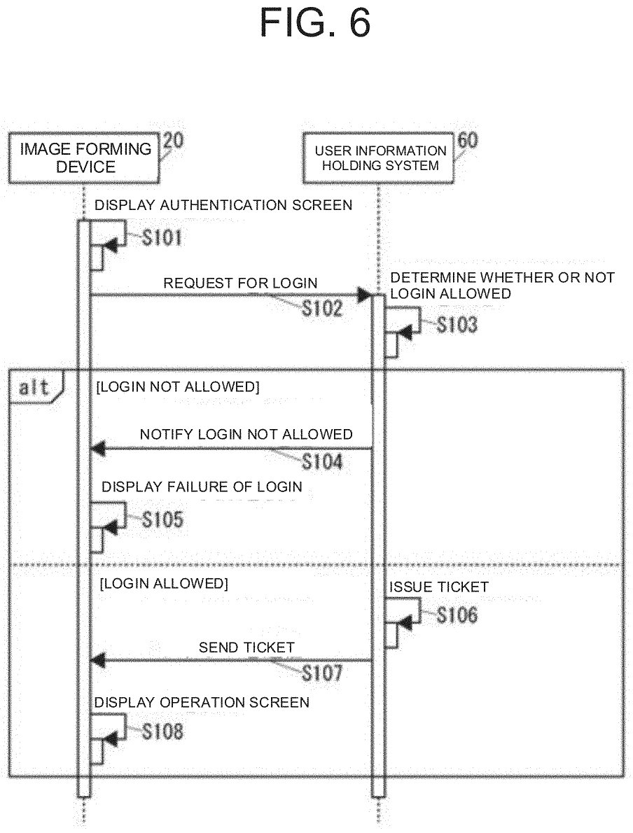

FIG. 6 is a sequence diagram of the operation of the information processing system 10 when the user logs in to the image forming device 20 by using the combination of the user name and the password.

The operation shown in FIG. 6 is an operation when the login method by using the combination of the user name and the password is shown in the login method information 27c in the image forming device 20.

As shown in FIG. 6, when the user is not in a state of logging in to the image forming device 20, the client application 28a of the image forming device 20 displays, on the display unit 22, the authentication screen for the user to log in to the image forming device 20 (S101). Here, since the login method by using the combination of the user name and the password is shown in the login method information 27c, the client application 28a adopts the login method by using the combination of the user name and the password as the login method on the authentication screen displayed in S101.

When login is instructed on the authentication screen displayed in S101, the client application 28a requests the user information holding system 60 for the user to log in (S102). This request includes the combination of the user name and the password which was input, by the user via the operation unit 21, on the authentication screen displayed in S101.

When receiving the request in S102, the user information holding system 60 determines whether or not to allow the user to log in (S103). Here, when the combination of the user name and the password included in the request in S102 is included in the combination of the user name and the password held by the user information holding system 60 itself, that is, when the authentication of the user is successful, the user information holding system 60 determines to allow the user to log in. On the other hand, when the combination of the user name and the password included in the request in S102 is not included in the combination of the user name and the password held by the user information holding system 60 itself, that is, when the authentication of the user fails, the user information holding system 60 determines not to allow the user to log in.

When the user information holding system 60 determines in S103 that the user's login is not allowed, the user information holding system 60 notifies the image forming device 20 that the user's login is not allowed (S104). Therefore, the client application 28a of the image forming device 20 displays the login failure on the display unit 22 (S105), and ends the operation shown in FIG. 6.

On the other hand, when determining in S103 that the user's login is allowed, the user information holding system 60 issues a ticket showing that the user information holding system 60 has allowed the user's login (S106), and sends, to the image forming device 20, the ticket issued in S106 (S107). Therefore, the client application 28a of the image forming device 20 displays, on the display unit 22, the operation screen that corresponds to the operation screen information 27d (S108), and ends the operation shown in FIG. 6.

Next, the operation of the information processing system 10 when the image forming device 20 uses the document processing flow execution system 40 by using the ticket sent from the user information holding system 60 will be described.

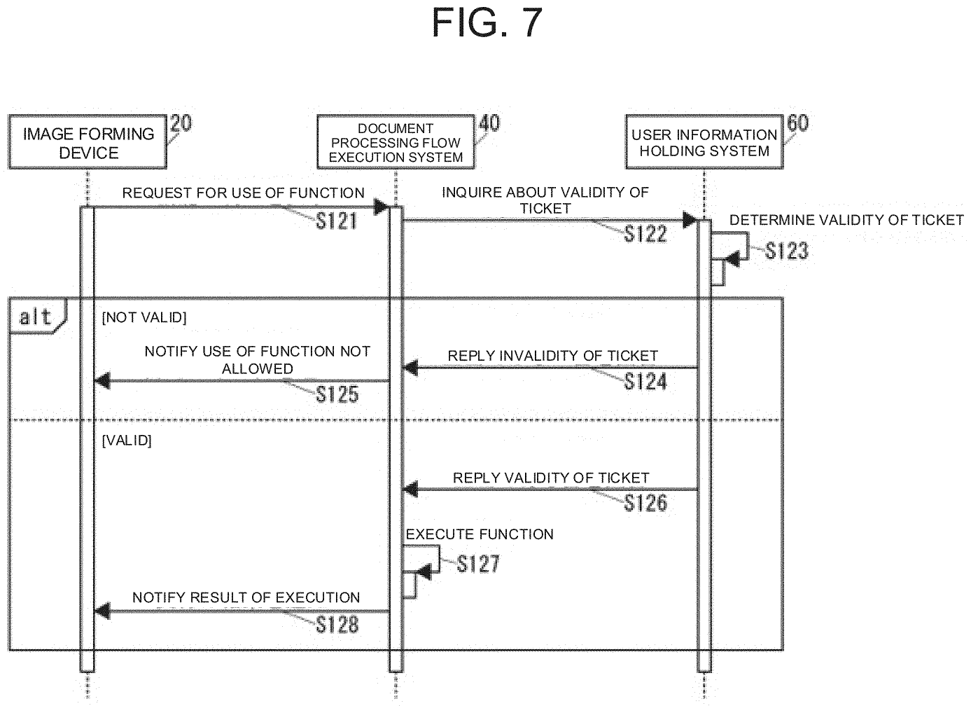

FIG. 7 is a sequence diagram of the operation of the information processing system 10 when the image forming device 20 uses the document processing flow execution system 40 by using the ticket sent from the user information holding system 60.

As shown in FIG. 7, the image forming device 20 requests the document processing flow execution system 40 to use the function of the document processing flow execution system 40 (S121). In the request in S121, the image forming device 20 includes the ticket sent from the user information holding system 60 in S107 (see FIG. 6).

When receiving the request in S121, the document processing flow execution system 40 inquires the user information holding system 60 about the validity of the ticket included in the request in S121 (S122).

When receiving the inquiry in S122, the user information holding system 60 determines the validity of the ticket whose validity was inquired about in S122 (S123).

When determining in S123 that the ticket whose validity was inquired about in S122 is not valid, the user information holding system 60 responds to the document processing flow execution system 40 that the ticket is not valid (S124). Therefore, the document processing flow execution system 40 notifies the image forming device 20 that the use of the function requested in S121 is not allowed (S125).

On the other hand, when determining in S123 that the ticket whose validity was inquired about in S122 is valid, the user information holding system 60 responds to the document processing flow execution system 40 that the ticket is valid (S126). Therefore, the document processing flow execution system 40 executes the function requested in S121 (S127), and notifies the image forming device 20 of the result of the execution in S127 (S128).

In the above, the case where the image forming device 20 uses the document processing flow execution system 40 by using the ticket sent from the user information holding system 60 has been described, but the same applies to the case where the image forming device 20 uses the authentication/authorization system 50 by using the ticket sent from the user information holding system 60.

Next, the operation of the information processing system 10 when the user logs in to the image forming device 20 by using the PIN code will be described.

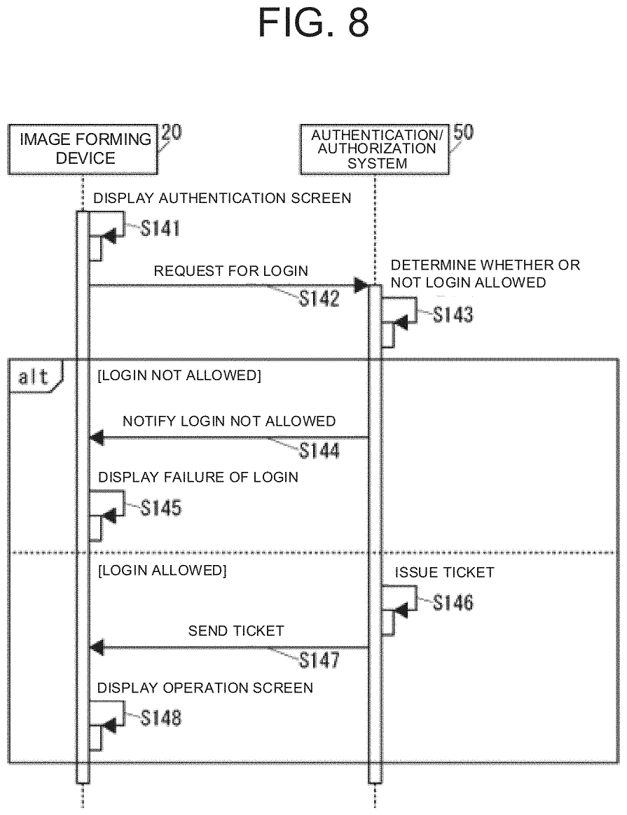

FIG. 8 is a sequence diagram of the operation of the information processing system 10 when the user logs in to the image forming device 20 by using the PIN code.

The operation shown in FIG. 8 is an operation when the login method by using the PIN code is shown in the login method information 27c in the image forming device 20.

As shown in FIG. 8, when the user is not in a state of logging in to the image forming device 20, the client application 28a of the image forming device 20 displays, on the display unit 22, the authentication screen for the user to log in to the image forming device 20 (S141). Here, since the login method by using the PIN code is shown in the login method information 27c, the client application 28a adopts the login method by using the PIN code as the login method on the authentication screen displayed in S141.

When login is instructed on the authentication screen displayed in S141, the client application 28a requests the authentication/authorization system 50 for the user to log in (S142). This request includes the PIN code which was input, by the user via the operation unit 21, on the authentication screen displayed in S141.

When receiving the request in S142, the authentication/authorization system 50 determines whether or not to allow the user to log in (S143). Here, when the PIN code held by the authentication/authorization system 50 itself includes the PIN code included in the request in S142, that is, when the authentication of the user is successful, the authentication/authorization system 50 determines to allow the user to log in. On the other hand, when the PIN code held by the authentication/authorization system 50 itself does not include the PIN code included in the request in S142, that is, when the authentication of the user fails, the authentication/authorization system 50 determines not to allow the user to log in.

When determining in S143 that the user's login is not allowed, the authentication/authorization system 50 notifies the image forming device 20 that the user's login is not allowed (S144). Therefore, the client application 28a of the image forming device 20 displays the login failure on the display unit 22 (S145), and ends the operation shown in FIG. 8.

On the other hand, when determining in S143 that the user's login is allowed, the authentication/authorization system 50 issues a ticket showing that the authentication/authorization system 50 allowed the user's login (S146), and sends, to the image forming device 20, the ticket issued in S146 (S147). Therefore, the client application 28a of the image forming device 20 displays, on the display unit 22, the operation screen that corresponds to the operation screen information 27d (S148), and ends the operation shown in FIG. 8.

In FIG. 8, the case where the user logs in to the image forming device 20 by using the PIN code has been described, but the same applies to the case where the user logs in to the image forming device 20 by using the IC card ID. However, when the user logs in to the image forming device 20 by using the IC card ID, the IC card ID read by the IC card reader (not shown) connected to the image forming device 20 is used instead of the PIN code.

Next, the operation of the information processing system 10 when the image forming device 20 uses the document processing flow execution system 40 by using the ticket sent from the authentication/authorization system 50 will be described.

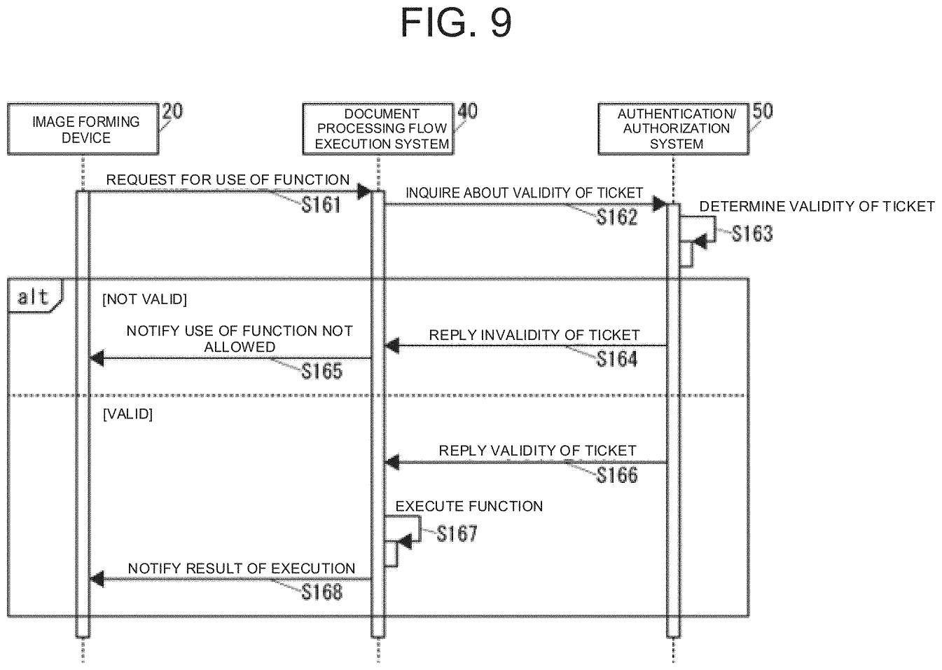

FIG. 9 is a sequence diagram of the operation of the information processing system 10 when the image forming device 20 uses the document processing flow execution system 40 by using the ticket sent from the authentication/authorization system 50.

As shown in FIG. 9, the image forming device 20 requests the document processing flow execution system 40 to use the function of the document processing flow execution system 40 (S161). In the request in S161, the image forming device 20 includes the ticket sent from the authentication/authorization system 50 in S147 (see FIG. 8).

When receiving the request in S161, the document processing flow execution system 40 inquires the authentication/authorization system 50 about the validity of the ticket included in the request in S161 (S162).

When receiving the inquiry in S162, the authentication/authorization system 50 determines the validity of the ticket whose validity was inquired about in S162 (S163).

When determining in S163 that the ticket whose validity was inquired about in S162 is not valid, the authentication/authorization system 50 responds to the document processing flow execution system 40 that the ticket is not valid (S164). Therefore, the document processing flow execution system 40 notifies the image forming device 20 that the use of the function requested in S161 is not allowed (S165).

On the other hand, when determining in S163 that the ticket whose validity was inquired about in S162 is valid, the authentication/authorization system 50 replies to the document processing flow execution system 40 that the ticket is valid (S166). Therefore, the document processing flow execution system 40 executes the function requested in S161 (S167), and notifies the image forming device 20 of the result of the execution in S167 (S168).

In the above, the case where the image forming device 20 uses the document processing flow execution system 40 by using the ticket sent from the authentication/authorization system 50 has been described, but the same applies to the case where the image forming device 20 uses the authentication/authorization system 50 by using the ticket sent from the authentication/authorization system 50.

Next, the operation of the user terminal 30 when the operation screen of the image forming device is edited will be described.

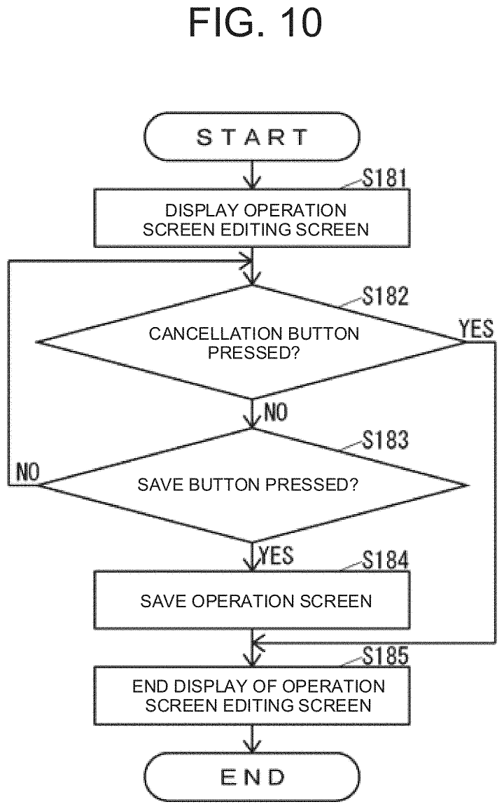

FIG. 10 is a flowchart of the operation of the user terminal 30 when the operation screen of the image forming device is edited.

When the start of editing the operation screen of the image forming device is instructed via the operation unit 31, the setting tool 35a of the user terminal 30 executes the operation shown in FIG. 10.

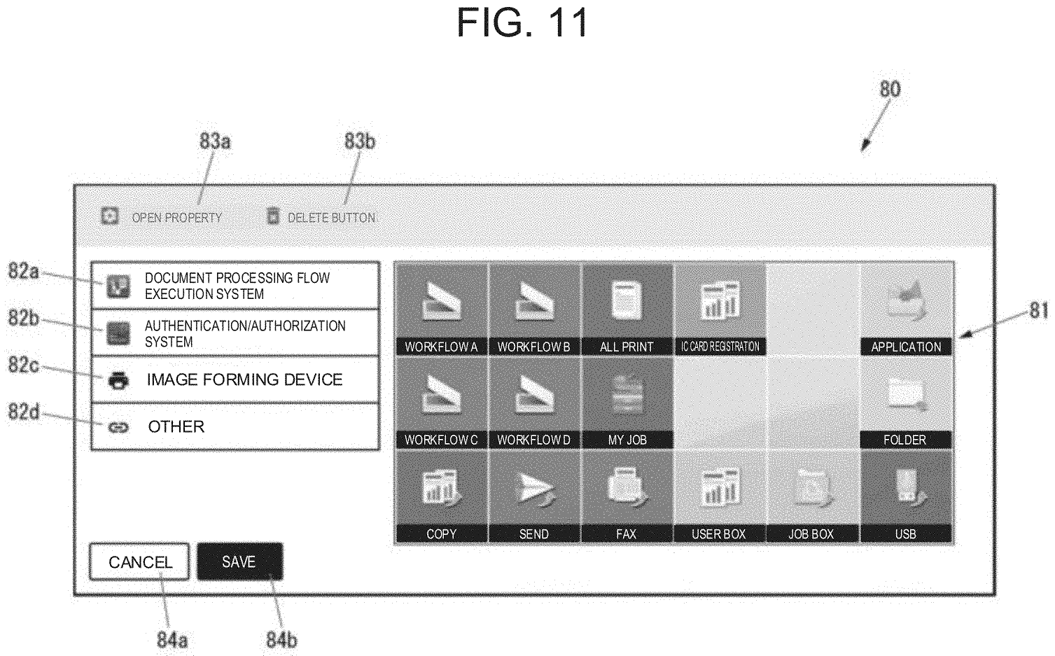

As shown in FIG. 10, the setting tool 35a displays, on the display unit 32, an operation screen editing screen 80 (see FIG. 11) for editing the operation screen of the image forming device (S181).

FIG. 11 is a diagram showing an example of the operation screen editing screen 80 displayed on the display unit 32.

As shown in FIG. 11, the operation screen editing screen 80 includes an operation screen area 81 showing an image of the operation screen of the image forming device. The operation screen area 81 is formed with a total of 18 rectangular areas having 3 rows vertically and 6 columns horizontally. One button is formed by one or more rectangular areas. That is, a maximum of 18 buttons can be arranged on the operation screen of the image forming device.

The operation screen editing screen 80 includes a “Document Processing Flow Execution System” button 82a for adding, to the operation screen area 81, buttons associated with the functions of the document processing flow execution system 40, for example, a “Workflow A” button, a “Workflow B” button, a “Workflow C” button, and a “Workflow D” button, an “Authentication/Authorization System” button 82b for adding, to the operation screen area 81, buttons associated with the functions of the authentication/authorization system 50, for example, the “Print All” button, the “My Job” button, and the “IC card registration” button, an “Image Forming Device” button 82c for adding, to the operation screen area 81, buttons associated with the functions of the image forming device, for example, the “Copy” button, the “Send” button, the “Fax” button, the “User Box” button, the “Job Box” button, the “USB” button, and the “Application” button, and an “Other” button 82d for adding the “Folder” button to the operation screen area 81.

The operation screen editing screen 80 is provided with an “Open Property” button 83a for setting the property of the button selected in the operation screen area 81 and a “Delete Button” button 83b for deleting the button selected in the operation screen area 81. The properties of the buttons include the placement, size, color, name, and icon image of the button in the operation screen area 81. The button color in the operation screen area 81 is the background color of the icon image of the button in the operation screen area 81. The name of the button in the operation screen area 81 is a character string arranged below the icon image in the button in the operation screen area 81.

The operation screen editing screen 80 includes a cancellation button 84a for canceling the editing of the operation screen of the image forming device, and a save button 84b for saving the operation screen of the image forming device.

As shown in FIG. 10, the setting tool 35a, after the process of S181, determines whether or not the cancellation button 84a is pressed (S182).

When determining in S182 that the cancellation button 84a is not pressed, the setting tool 35a determines whether or not the save button 84b is pressed (S183).

When determining in S183 that the save button 84b is not pressed, the setting tool 35a executes the process of S182.

When determining in S183 that the save button 84b is pressed, the setting tool 35a saves the operation screen of the image forming device set in the operation screen editing screen 80 (S184).

When determining in S182 that the cancellation button 84a is pressed or when executing the process of S184, the setting tool 35a ends the display of the operation screen editing screen 80 by the display unit 32 (S185), and ends the operation shown in FIG. 10.

When editing the operation screen of the image forming device, the setting tool 35a causes the user to specify the login method of the image forming device, and saves the login method, which is specified by the user, in a manner corresponding to the operation screen saved in S184.

Next, the operation of the information processing system 10 when various information of the operation screen is sent from the user terminal 30 to the image forming device 20 will be described.

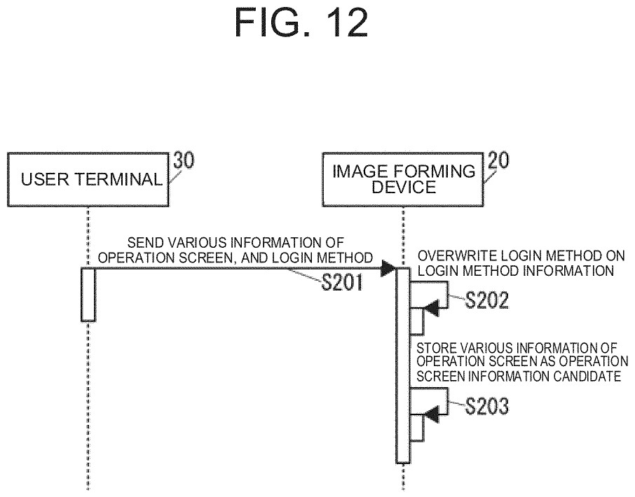

FIG. 12 is a sequence diagram of the operation of the information processing system 10 when various information of the operation screen is sent from the user terminal 30 to the image forming device 20.

When being instructed via the operation unit 31 to send, to the image forming device 20, various information of the operation screen saved in S184 (see FIG. 10), the setting tool 35a of the user terminal 30, as shown in FIG. 12, sends, to the image forming device 20, various information of the operation screen saved in S184 and the login method which is saved in a manner corresponding to the operation screen (S201).

When receiving the various information and the login method which are sent from the user terminal 30 in S201, the client application 28a of the image forming device 20 overwrites the login method, which is sent from the user terminal 30 in S201, on the login method information 27c (S202).

Next, the client application 28a stores, as the operation screen information candidate 27e, various information, on the operation screen, sent from the user terminal 30 in S201 (S203).

In the example shown in FIG. 12, various information of the operation screen is sent from the user terminal 30 to the image forming device 20, but various information of the same operation screen may be sent at the same time from the user terminal 30 to a plurality of image forming devices.

Next, the operation of the image forming device 20 when the operation screen information 27d is updated will be described.

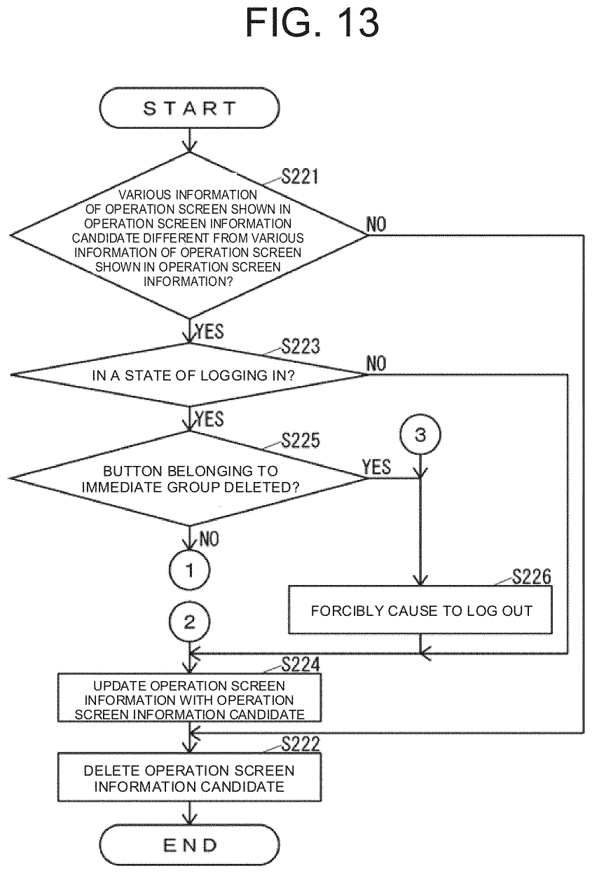

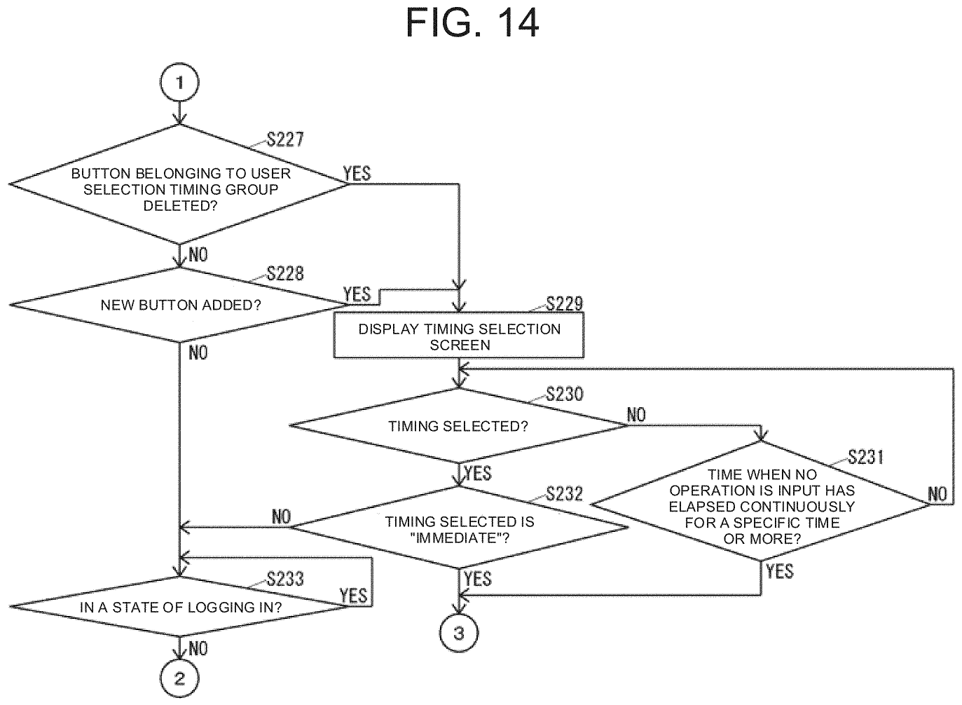

FIG. 13 is a flow chart of a part of the operation of the image forming device 20 when the operation screen information 27d is updated. FIG. 14 is a flowchart of an operation following the operation shown in FIG. 13.

The client application 28a of the image forming device 20 executes the operations shown in FIG. 13 and FIG. 14 when the operation screen information candidate 27e is stored in S203 (see FIG. 12).

As shown in FIG. 13 and FIG. 14, the client application 28a determines whether or not various information of the operation screen shown in the operation screen information candidate 27e is different from various information of the operation screen shown in the operation screen information 27d (S221).

When determining in S221 that the various information of the operation screen shown in the operation screen information candidate 27e is not different from the various information of the operation screen shown in the operation screen information 27d, the client application 28a deletes the operation screen information candidate 27e from the storage unit 27 (S222), and ends the operations shown in FIG. 13 and FIG. 14.

When determining in S221 that the various information of the operation screen shown in the operation screen information candidate 27e is different from the various information of the operation screen shown in the operation screen information 27d, the client application 28a determines whether or not the user is in a state of logging in to the image forming device 20 (S223).

When determining in S223 that the user is not in a state of logging in to the image forming device 20, the client application 28a, updates the operation screen information 27d with the operation screen information candidate 27e (S224), thereafter executes the process of S222, and ends the operations shown in FIG. 13 and FIG. 14.

When determining in S223 that the user is in a state of logging in to the image forming device 20, the client application 28a determines whether or not the button belonging to the immediate group is deleted in view of the operation screen corresponding to the operation screen information candidate 27e with respect to the operation screen corresponding to the operation screen information 27d (S225).

When determining in S225 that the button belonging to the immediate group is deleted in view of the operation screen corresponding to the operation screen information candidate 27e with respect to the operation screen corresponding to the operation screen information 27d, the client application 28a forcibly causes the user to log out from the image forming device 20 (S226). Next, the client application 28a executes the processes of S224 and S222 in order, and ends the operations shown in FIG. 13 and FIG. 14.

When determining in S225 that the button belonging to the immediate group is not deleted in view of the operation screen corresponding to the operation screen information candidate 27e with respect to the operation screen corresponding to the operation screen information 27d, the client application 28a determines whether or not the button belonging to the user selection timing group is deleted in view of the operation screen corresponding to the operation screen information candidate 27e with respect to the operation screen corresponding to the operation screen information 27d (S227).

When determining in S227 that the button belonging to the user selection timing group is not deleted in view of the operation screen corresponding to the operation screen information candidate 27e with respect to the operation screen corresponding to the operation screen information 27d, the client application 28a determines whether or not a new button is added in view of the operation screen corresponding to the operation screen information candidate 27e with respect to the operation screen corresponding to the operation screen information 27d (S228).

When determining in S227 that the button belonging to the user selection timing group is deleted in view of the operation screen corresponding to the operation screen information candidate 27e with respect to the operation screen corresponding to the operation screen information 27d, or when determining in S228 that the new button is added in view of the operation screen corresponding to the operation screen information candidate 27e with respect to the operation screen corresponding to the operation screen information 27d, the client application 28a displays a screen (hereinafter referred to as “timing selection screen”) for causing the user to select the timing when the update of the operation screen is reflected (S229).

Here, the timings that can be selected on the timing selection screen include “immediate” in which the update of the operation screen is immediately reflected, and “after logout” in which the update of the operation screen is reflected after the user logs out from the image forming device 20.

After the process of S229, the client application 28a determines whether or not the timing that reflects the update of the operation screen is selected on the timing selection screen (S230).

When determining in S230 that the timing that reflects the update of the operation screen is not selected in the timing selection screen, the client application 28a determines whether or not the time when the operation is not input to the operation unit 21 has elapsed continuously for a specific time or more after the process in S229 (S231).

When determining in S231 that the time when the operation is not input to the operation unit 21 has not elapsed continuously for a specific time or more after the process in S229, the client application 28a executes the process in S230.

When determining in S230 that the timing that reflects the update of the operation screen is selected on the timing selection screen, the client application 28a determines whether or not the timing selected on the timing selection screen is “immediate” (S232).

When determining in S231 that the time when no operation is input to the operation unit 21 has elapsed continuously for a specific time or more after the process of S229, or when determining in S232 that the timing selected on the timing selection screen is “immediate, the client application 28a executes the processes of S226, S224, and S222 in order, and ends the operations shown in FIG. 13 and FIG. 14.

When determining in S228 that the new button is not added in view of the operation screen corresponding to the operation screen information candidate 27e with respect to the operation screen corresponding to the operation screen information 27d, or when determining in S232 that the timing selected on the timing selection screen is not “immediate”, that is, the timing is “after logout”, the client application 28a determines, until determining that the user is not in a state of logging in to the image forming device 20, whether or not the user is in a state of logging in to the image forming device 20 (S233). Then, when determining in S233 that the user is not in a state of logging in to the image forming device 20, the client application 28a executes the processes of S224 and S222 in order, and ends the operations shown in FIG. 13 and FIG. 14.

The client application 28a holds login information such as the combination of the user name and the password, the PIN code, and the IC card ID used when the user logs in to the image forming device 20. Thereby, when executing the process of S226 and ending the operations shown in FIG. 13 and FIG. 14, the client application 28a may cause the user to automatically log in to the image forming device 20 again by using the held login information.

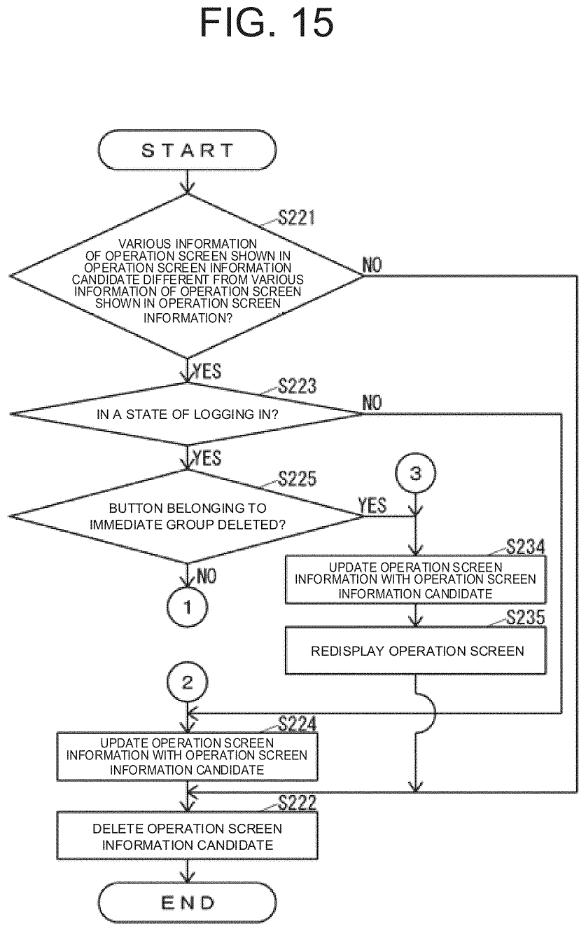

In the operations shown in FIG. 13 and FIG. 14, when determining in S225 that the button belonging to the immediate group is deleted in view of the operation screen corresponding to the operation screen information candidate 27e with respect to the operation screen corresponding to the operation screen information 27d, when determining in S231 that the time when no operation is input to the operation unit 21 has elapsed continuously for a specific time or more after the process of S229, or when determining in S232 that the timing selected on the timing selection screen is “immediate”, the client application 28a executes the process of S226. However, as shown in FIG. 15, when determining in S225 that the button belonging to the immediate group is deleted in view of the operation screen corresponding to the operation screen information candidate 27e with respect to the operation screen corresponding to the operation screen information 27d, when determining in S231 that the time when no operation is input to the operation unit 21 has elapsed continuously for a specific time or more after the process in S229, or when determining in S232 that the timing selected on the timing selection screen is “immediate”, the client application 28a, by omitting the process of S226 (see FIG. 13), that is, the process of forcibly causing the user to log out from the image forming device 20, may update the operation screen information 27d with the operation screen information candidate 27e (S234), thereafter may execute the process of redisplaying, on the display unit 22, the operation screen corresponding to the operation screen information 27d (S235), and thereby may execute the process of S222.

As described above, at the timing (S225 to S233) according to the contents of the difference between the various information of the operation screen shown in the operation screen information candidate 27e stored by the image forming device 20 itself and the various information of the operation screen shown in the operation screen information 27d stored by the image forming device 20 itself, the image forming device 20 updates the operation screen information 27d with the operation screen information candidate 27e (S224), thus making it possible to improve appropriateness of the timing of updating the operation screen.

At the timing (“YES in S225, and S226”, “NO in S225, YES in S227, S229 to S233 and S226”, and “NO in S225, NO in S227, NO in S228, and S233”) according to the type of the button which is deleted in view of the operation screen corresponding to the operation screen information candidate 27e stored by the image forming device 20 itself with respect to the operation screen corresponding to the operation screen information 27d stored by the image forming device 20 itself, the image forming device 20 updates the operation screen information 27d with the operation screen information candidate 27e, thus making it possible to update the operation screen at the timing according to the type of the deleted button.

In the case where the button belonging to the immediate group is deleted in view of the operation screen corresponding to the operation screen information candidate 27e stored by the image forming device 20 itself with respect to the operation screen corresponding to the operation screen information 27d stored by the image forming device 20 itself (YES in S225), the image forming device 20, at the timing (S226) earlier compared with the case where the button belonging to the immediate group is not deleted, updates the operation screen information 27d with the operation screen information candidate 27e, thus making it possible to update the operation screen at the timing appropriate for the case where the button belonging to the immediate group is deleted.

In the case where the button belonging to the immediate group is not deleted (NO in S225) and the button belonging to the user selection timing group is deleted (YES in S227), in view of the operation screen corresponding to the operation screen information candidate 27e stored by the image forming device 20 itself with respect to the operation screen corresponding to the operation screen information 27d stored by the image forming device 20 itself, the image forming device 20, at the timing (S229 to S233 and S226) selected by the user, updates the operation screen information 27d with the operation screen information candidate 27e, thereby making it possible to update the operation screen at the timing appropriate for the case where the button belonging to the immediate group is not deleted and the button belonging to the user selection timing group is deleted.

In the case where the button belonging to the immediate group is not deleted (NO in S225) and the button is added (YES in S228), in view of the operation screen corresponding to the operation screen information candidate 27e stored by the image forming device 20 itself with respect to the operation screen corresponding to the operation screen information 27d stored by the image forming device 20 itself, the image forming device 20, at the timing selected by the user (S229 to S233 and S226), updates the operation screen information 27d with the operation screen information candidate 27e, thus making it possible to improve appropriateness of the timing of updating the operation screen.

In the case where the user is in a state of logging in to the image forming device 20, when the button is neither added nor deleted (NO in S225, NO in S227, and NO in S228) in view of the operation screen corresponding to the operation screen information candidate 27e stored by the image forming device 20 itself with respect to the operation screen corresponding to the operation screen information 27d stored by the image forming device 20 itself, and when the property of the button is changed, after the user logs out from the image forming device 20 (NO in S223), the image forming device 20 updates the operation screen information 27d with the operation screen information candidate 27e, thus making it possible to improve appropriateness of the timing of updating the operation screen.

Regardless of whether or not the user is in a state of logging in to the image forming device 20, the user terminal 30 can send, to the image forming device 20, the various information of the operation screen, of the image forming device, set on the operation screen editing screen 80 (S201), and therefore the information processing system 10 can reduce the work load of maintenance related to updating of the operation screen in the image forming device 20. Further, when the user terminal 30 sends, to the image forming device 20, the various information of the operation screen, of the image forming device, set on the operation screen editing screen 80, the user may be in a state of logging in to the image forming device 20, and therefore the information processing system 10 can reduce the downtime of the image forming device 20.

What is claimed is:

1. An electronic device, comprising the following operations:
storing operation screen information showing various information of an operation screen in the electronic device;
displaying the operation screen that corresponds to the operation screen information stored by the electronic device itself;
storing, as a candidate for the operation screen information, various information of a new operation screen, sent from outside; and
updating, at a timing according to contents of a difference between the various information of the operation screen shown in the candidate stored by the electronic device itself and the various information of the operation screen shown in the operation screen information stored by the electronic device itself, the operation screen information stored by the electronic device itself with the candidate stored by the electronic device itself.

2. The electronic device according to claim 1, wherein
the timing is according to a type of a button which is deleted in view of the operation screen corresponding to the candidate stored by the electronic device itself with respect to the operation screen corresponding to the operation screen information stored by the electronic device itself.

3. The electronic device according to claim 2, wherein
a group of buttons that may be included in the operation screen includes an immediate group showing a group of buttons with which update of the operation screen is immediately reflected when the buttons themselves are deleted, and
the timing is earlier in a case where the button belonging to the immediate group is deleted in view of the operation screen corresponding to the candidate stored by the electronic device itself with respect to the operation screen corresponding to the operation screen information stored by the electronic device itself compared with a case where the button belonging to the immediate group is not deleted.

4. The electronic device according to claim 3, wherein
a group of buttons that may be included in the operation screen includes a user selection timing group that shows a group of buttons with which the timing is selected by a user, and
the timing is selected by the user in a case where the button belonging to the immediate group is not deleted and the button belonging to the user selection timing group is deleted, in view of the operation screen corresponding to the candidate stored by the electronic device itself with respect to the operation screen corresponding to the operation screen information stored by the electronic device itself.

5. The electronic device according to claim 3, wherein
the timing is selected by the user in a case where the button belonging to the immediate group is not deleted and a button is added, in view of the operation screen corresponding to the candidate stored by the electronic device itself with respect to the operation screen corresponding to the operation screen information stored by the electronic device itself.

6. The electronic device according to claim 1, wherein
the timing is after a user logs out from the electronic device, in a case where the user is in a state of logging in to the electronic device, when the button is neither added nor deleted in view of the operation screen corresponding to the candidate stored by the electronic device itself with respect to the operation screen corresponding to the operation screen information stored by the electronic device itself, and when a property of the button is changed.

7. A computer-readable non-temporary recording medium storing an operation screen control program for controlling an operation screen in an electronic device, the operation screen control program comprising the following operations:
causing the electronic device to store operation screen information showing various information of the operation screen;
causing the electronic device to display the operation screen that corresponds to the operation screen information stored by the electronic device;
causing the electronic device to store, as a candidate for the operation screen information, various information of a new operation screen, sent from outside of the electronic device to the electronic device; and
causing the electronic device to update, at a timing according to contents of a difference between the various information of the operation screen shown in the candidate stored by the electronic device and the various information of the operation screen shown in the operation screen information stored by the electronic device, the operation screen information stored by the electronic device with the candidate stored by the electronic device.

8. An information processing system, comprising:
an electronic device; and
a setting device that sets an operation screen in the electronic device,
wherein
the electronic device stores operation screen information showing various information of the operation screen,
the electronic device displays the operation screen that corresponds to the operation screen information stored by the electronic device itself,
the setting device sends various information of a new operation screen to the electronic device,
the electronic device stores, as a candidate for the operation screen information, the various information of the new operation screen sent from the setting device, and
the electronic device updates, at a timing according to contents of a difference between the various information of the operation screen shown in the candidate stored by the electronic device itself and the various information of the operation screen shown in the operation screen information stored by the electronic device itself, the operation screen information stored by the electronic device itself with the candidate stored by the electronic device itself.
